(19) United States
(12) Patent Application Publication
(10) Pub. No.: US 2008/0267227 A1
(43) Pub. Date: Oct. 30, 2008

(54) Gain-clamped optical amplifier using double-clad fiber

(75) Inventors: Hong Seok Seo, Daejeon (KR); Joon Tae Ahn, Daejeon (KR); Bong Je Park, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Reserach Institute

(21) Appl. No.: 11/982,166

(22) Filed: Oct. 31, 2007

(30) Foreign Application Priority Data
Dec. 5, 2006 (KR) 2006-122542
Jun. 12, 2007 (KR) 2007-57143

(51) Int. Cl. H01S 3/30

(52) U.S. Cl. 372/6

(57) ABSTRACT

Provided is a gain-clamped optical amplifier amplifying light without bandwidth loss of an incident optical signal, and the gain-clamped optical amplifier using a double-clad fiber comprises: an optical fiber including a core doped with a gain material for amplifying an optical signal, a primary clad adjacent to the outside of the core and having a lower refractive index than the core, and a secondary clad adjacent to the outside of the primary clad and having a lower refractive index than the primary clad; a light emitting element emitting a pump light for population inversion of the gain material; and a cavity unit producing laser oscillation by resonating spontaneous emission light emitted from the gain material population-inverted by the pump light.

### CROSS-REFERENCE TO RELATED APPLICATION

This application claims priority to and the benefit of Korean Patent Application No. 2006-122542, filed Dec. 5, 2006, and No. 2007-57143, filed Jun. 12, 2007, the disclosure of which is incorporated herein by reference in its entirety.

### BACKGROUND

1. Field of the Invention

The present invention relates to an optical amplifier, and more particularly, to a gain-clamped optical amplifier having a constant gain regardless of the strength of an incident optical signal.

2. Discussion of Related Art

An optical amplifier is an optical element that amplifies the strength of an incident optical signal. An optical amplifier is used to compensate for optical loss in various optical elements or optical network fiber.

In a conventional optical amplifier, the degree of amplification varies depending on the strength of the incident optical signal. This reduces communication quality in an optical network. To deal with this problem, a gain clamped fiber amplifier was developed.

The manner of gain clamping includes all-optical gain clamping whereby the gain is optically clamped by laser oscillation, and electronically adjusting the strength of pump light depending on the strength of incident light. Adjusting the strength of pump light for clamping the gain requires a complex signal processing procedure. Thus, more research has been focused on all-optical gain clamping.

All-optical gain clamping involves forming a cavity within a band where optical amplification is needed and inducing laser oscillation therein to clamp the magnitude of population inversion of gain material. That is, the gain of the optical amplifier is proportional to the length of the gain material and the magnitude of the population inversion, and thus the gain of the optical amplifier is clamped by the laser oscillation.

FIG. 1 is a diagram illustrating a conventional gain-clamped optical fiber amplifier designed for all-optical amplification. Referring to FIG. 1, pump light output from a laser diode (LD; 111) is incident on an optical fiber 120 through a wavelength division multiplexing (WDM) coupler 110.

An attenuator (ATT; 140), an isolator (ISO; 150), and a band pass filter (BPF; 160), which are connected between couplers 100 and 130 of input and output terminals, constitute a ring cavity for laser oscillation. The ATT 140 controls the power of the laser in the cavity to adjust the gain of an optical signal, the ISO 150 makes the oscillation occur toward only one direction in the ring cavity, and the BPF 160 fixes the oscillation wavelength. When a weak optical signal is incident on the gain clamped amplifier shown in FIG. 1, the strength of oscillating laser light relatively increases, and when a strong optical signal is incident thereon, the strength of oscillating laser light becomes weak. Thus, the gain is clamped according to the incident optical signal.

However, in the case of the gain-clamped optical amplifier described above, the laser is formed within an amplification band, so that a transmission bandwidth of the optical signal is reduced by the bandwidth occupied by the laser.

### SUMMARY OF THE INVENTION

The present invention is directed to a gain-clamped optical amplifier for amplifying light without bandwidth loss of an incident optical signal.

One aspect of the present invention provides a gain-clamped optical amplifier using a double-clad fiber, which comprises: an optical fiber including a core doped with a gain material for amplifying an optical signal, a primary clad adjacent to the outside of the core and having a lower refractive index than the core, and a secondary clad adjacent to the outside of the primary clad and having a lower refractive index than the primary clad; a light emitting element emitting a pump light for population inversion of the gain material; and a cavity unit producing a gain clamping laser in the primary clad by resonating spontaneous emission light emitted from the gain material population-inverted by the pump light.

Another aspect of the present invention provides a gain-clamped optical amplifier using a double-clad fiber, which comprises: an optical fiber including a core doped with a gain material for amplifying an optical signal, a primary clad adjacent to the outside of the core and having a lower refractive index than the core, and a secondary clad adjacent to the outside of the primary clad and having a reflector reflecting incident light; a pump coupler disposed at both ends of the optical fiber, merging a plurality of input terminals into one output terminal, and outputting a signal to the optical fiber; and a light emitting element connected to the pump coupler and emitting a pump light for population inversion of the gain material, wherein the secondary clad reflects spontaneous emission light emitted from the gain material population-inverted by the pump light to be amplified in the primary clad so that laser oscillation is achieved.

### BRIEF DESCRIPTION OF THE DRAWINGS

FIG. 1 is a diagram illustrating a conventional gain-clamped optical fiber amplifier employing all-optical amplification.

FIG. 2A is a diagram illustrating a gain-clamped optical amplifier using a double-clad fiber according to a first exemplary embodiment of the present invention;

FIG. 2B is a cross-sectional view at both ends of a double-clad fiber in FIG. 2A;

FIG. 3A is a diagram illustrating a gain-clamped optical amplifier using a double-clad fiber according to a second exemplary embodiment of the present invention;

FIG. 3B is a diagram illustrating a pump coupler shown in FIG. 3A in detail;

FIG. 4A is a diagram illustrating a gain-clamped optical amplifier using a double-clad fiber according to a third exemplary embodiment of the present invention;

FIG. 4B is a diagram illustrating a pump coupler shown in FIG. 4A in detail;

FIG. 5A is a diagram illustrating a gain-clamped optical amplifier using a double-clad fiber according to a fourth exemplary embodiment of the present invention;

FIG. 5B is a diagram illustrating a pump coupler and a reflector shown in FIG. 5A in detail;

FIG. 6A is a diagram illustrating a gain-clamped optical amplifier using a double-clad fiber according to a fifth exemplary embodiment of the present invention;

FIG. 6B is a diagram illustrating a pump coupler and a reflector shown in FIG. 6A in detail;

FIG. 7A is a diagram illustrating a gain-clamped optical amplifier using a double-clad fiber according to a sixth exemplary embodiment of the present invention;

FIG. 7B is a diagram illustrating coupling of an optical fiber shown in FIG. 7A in detail;

FIG. 8A is a diagram illustrating a gain-clamped optical amplifier using a double-clad fiber according to a seventh exemplary embodiment of the present invention;

FIG. 8B is a diagram illustrating coupling of an optical fiber and a reflector shown in FIG. 8A in detail;

FIG. 9A is a diagram illustrating a gain-clamped optical amplifier using a double-clad fiber according to an eighth exemplary embodiment of the present invention; and

FIG. 9B is a diagram illustrating the double-clad fiber shown in FIG. 9A in detail.

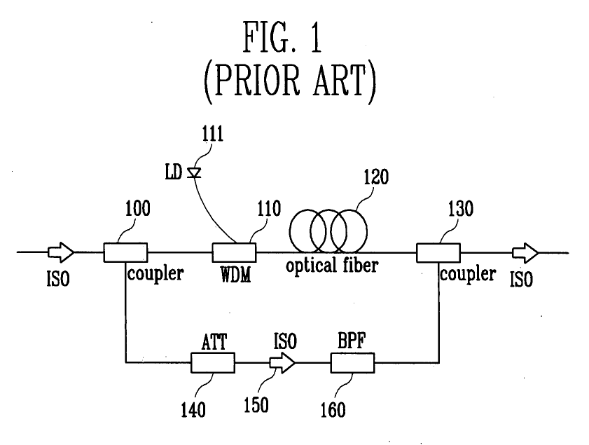

### DETAILED DESCRIPTION OF PREFERRED EMBODIMENTS

Hereinafter, exemplary embodiments of the present invention will be described in detail. However, the present invention is not limited to the exemplary embodiments disclosed below, but can be implemented in various modified forms. The below exemplary embodiments are provided to fully enable those of ordinary skill in the art to embody and practice the invention.

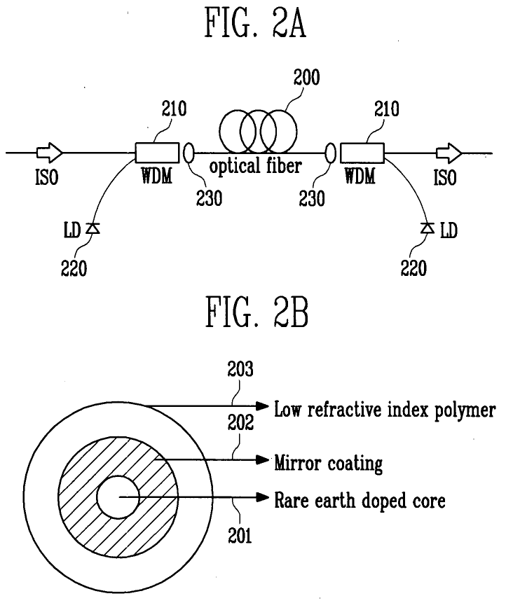

FIG. 2A is a diagram illustrating a gain-clamped optical amplifier using a double-clad fiber according to a first exemplary embodiment of the present invention, and FIG. 2B is a cross-sectional view at both ends of a double-clad optical fiber 200 according to the first exemplary embodiment of the present invention;

The gain-clamped optical amplifier using a double-clad fiber according to the first exemplary embodiment of the present invention includes an optical fiber 200 having a double-clad structure, a laser diode 220 emitting a pump light, a WDM coupler 210 outputting an incident optical signal and pumping light to an objective lens 230, and the objective lens 230 making the optical signal and the pump light output from the WDM coupler 210 incident on a core 201 of the optical fiber 200 having the double-clad structure.

A principle of the gain-clamped optical amplifier using the double-clad structure according to the first exemplary embodiment of the present invention will be first described with reference to FIG. 2A.

The optical signal passing through an isolator and the pump light emitted from the laser diode 220 are entered to the objective lens 230 through the WDM coupler 210. The objective lens 230 makes the received optical signal and the pump light incident on the core 201 of the optical fiber 200 having the double-clad structure.

At this time, the pump light excites an energy potential of the gain material doped into the core 201 from a ground state to an excited state while propagating along the core 201, thereby causing population inversion. That is, the number of excited atoms exceeds the number of atoms in the ground state. At this time, the excited atoms emit light and return to the ground state through spontaneous emission, and the spontaneous emission light is also amplified while propagating through the gain material, which is referred to as Amplified Spontaneous Emission (ASE).

Among the spontaneous emission, some emitted from the core 210 can propagate along the primary clad, cross the core 201 and then come out to the primary clad 202 again. The reason why the spontaneous emission light entering the core 201 from the primary clad does not propagate along the core 201 is that it does not meet guiding condition in the core 201 and thus leaks out into the primary clad 202. The spontaneous emission light is supplied with energy from the core 201 while entering and coming out of the core 201, and is reflected and oscillated through two mirrors at both ends of the optical fiber 200 having the double-clad structure.

A structure for reflecting the spontaneous emission light at both ends of the optical fiber having the double-clad structure will be described with reference to FIG. 2B.

The core 201 may be doped with a rare earth element such as erbium, neodymium, etc. and has a higher refractive index than the primary clad 202.

The primary clad 202 has a lower refractive index than the core 201, and may be formed of silica. A reflector for reflecting the spontaneous emission light is disposed at each end of the primary clad 202. The reflector may be a general mirror or a dielectric coated on the end of the optical fiber.

The secondary clad 203 has a lower refractive index than the primary clad 202 and may be formed of silica glass doped with fluorine, or a polymer. The optical fiber 200 having the double-clad structure shown in FIG. 2B is applied to other exemplary embodiments of the present invention described below.

Referring back to FIG. 2A, spontaneous emission light reaching either end of the optical fiber 200 having the double-clad structure is reflected at the reflectors disposed at both ends of the primary clad 202 and thus is continuously amplified while propagating back and forth. Consequently, laser oscillation can be achieved in the primary clad 202 by means of continuous reflection and amplification of the spontaneous emission light.

Such a laser signal has a complementary relationship with an optical signal while adjusting a value of the population inversion. That is, the power of the laser formed in the primary clad 202 increases when the optical signal becomes weaker and decreases when the optical signal becomes stronger, so that the gain of the optical amplifier is clamped.

According to the first exemplary embodiment of the present invention as described above, laser oscillation is achieved in the primary clad 202 and thus the gain can be clamped without bandwidth loss of the optical signal propagating toward the core 201.

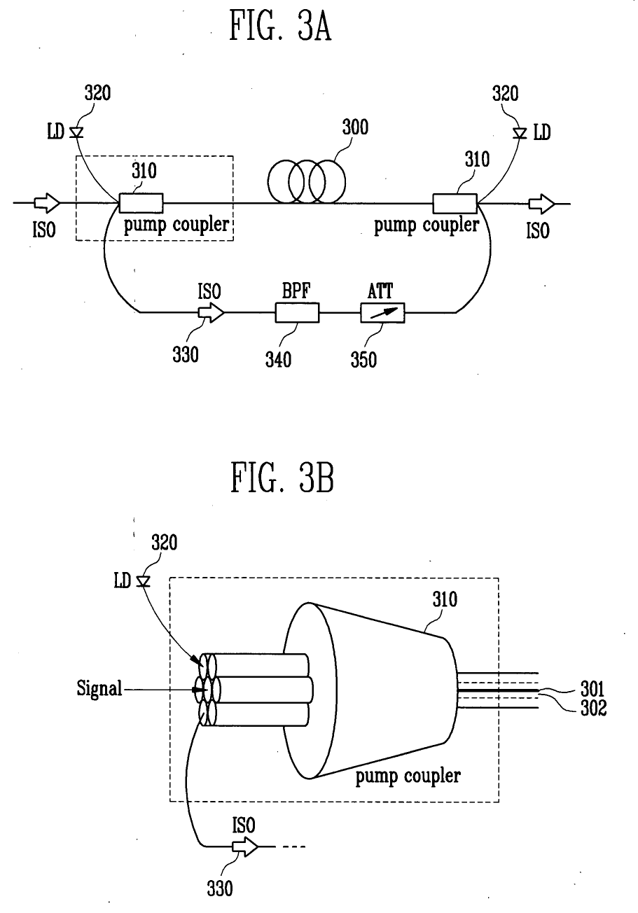

FIG. 3A is a diagram illustrating a gain-clamped optical amplifier using a double-clad fiber according to a second exemplary embodiment of the present invention, and FIG. 3B is a diagram illustrating a pump coupler shown in FIG. 3A in detail. A structure of the pump coupler is disclosed in U.S. Pat. No. 5,864,644 entitled “Tapered Fiber Bundles for Coupling Light Into and Out Of Cladding-Pumped Fiber Devices.” The structure and principle of the gain-clamped optical amplifier using a double-clad structure according to the second exemplary embodiment of the present invention will be described with reference to FIG. 3.

The gain-clamped optical amplifier using a double-clad structure according to the second exemplary embodiment of the present invention includes an optical fiber 300 having a double-clad structure, pump couplers 310 disposed at each end of the optical fiber 300 and connecting the optical fiber 300 to a laser diode 320 with a pump light, and a cavity disposed along a different path from the optical fiber 300 between the pump couplers 310 and having an ISO 330, a BPF 340 and an ATT 350.

Referring to FIG. 3A, an optical signal passing through the ISO and pump light output from the laser diode 320 are incident on the optical fiber 300 through the pump coupler 310.

The structure and role of the pump coupler 310 will be described with reference to FIG. 3B.

In general, seven optical fibers composed of one central optical fiber and six surrounding optical fibers are disposed at an input terminal of the pump coupler 310, and one optical fiber put together from the seven optical fibers is disposed at an output terminal thereof. The number of optical fibers of the input terminal is not limited to seven, and may be enough when it is three or more.

In the pump coupler 310 according to the second exemplary embodiment of the present invention, the central optical fiber to which an optical signal is input is connected to the core 301 of the optical fiber 300 having the double-clad structure, and the six surrounding optical fibers are connected to the primary clad 302 of the optical fiber 300 having the double-clad structure. Pump light output from the laser diode 320 is input to optical fibers surrounding the central optical fiber, and one of the six optical fibers is used to form a cavity connecting the pump couplers 310 disposed at both ends of the optical fiber 300 having the double-clad structure.

Referring again to FIG. 3A, the pump light output from the laser diode 320 is incident on the primary clad 302 of the optical fiber 300 having the double-clad structure in the pump coupler 310. The incident pump light excites the gain material doped into the core 301, and the core 301 is population-inverted. The optical signal passing through the ISO is then incident on the core 301 of the optical fiber 300 having the double-clad structure from the pump coupler 310 and is amplified while propagating along the core 301. At this time, spontaneous emission light is generated from the core 310 as in the first exemplary embodiment of the present invention.

Among the spontaneous emission light, some meeting a guiding condition in the primary clad 302 propagate along the primary clad 302 and some of it cross the core 301 and then comes back out to the primary clad 302. In result, the spontaneous emission light achieves energy from the gain material doped into the core 301 and is amplified while entering and coming out of the core 301.

Since both ends of the optical fiber 300 having the double-clad structure are connected to the cavity, the amplified spontaneous emission light produces an oscillation in the primary clad 302. At this time, the laser oscillation is achieved when the spontaneous emission light exceed the total loss of the cavity.

The laser formed in the primary clad 302 does not interfere with the optical signal propagating toward the core 301 as long as the core 301 does not have a distorted region or a locally varying refractive index.

The generated laser signal has complementary relationship with an optical signal while adjusting a value of the population inversion. That is, the power of the laser formed in the primary clad 302 increases when the optical signal becomes weaker and decreases when the optical signal becomes stronger, so that the gain of the optical amplifier is clamped.

Referring to the configuration of the cavity, the cavity includes an ISO 330, a BPF 340, and an ATT 350.

The ISO 330 makes the laser oscillation toward only one direction in the ring cavity, the BPF 340 adjusts the oscillation wavelength, and the ATT 350 controls the power of the laser in the cavity to adjust the gain of an optical signal.

Two pump couplers 310 and two laser diodes 320 are shown at both ends of the optical fiber 300 having the double-clad structure, but one pump coupler 310 and one laser diode 320 may be present, or a plurality of laser diodes 320 may be present.

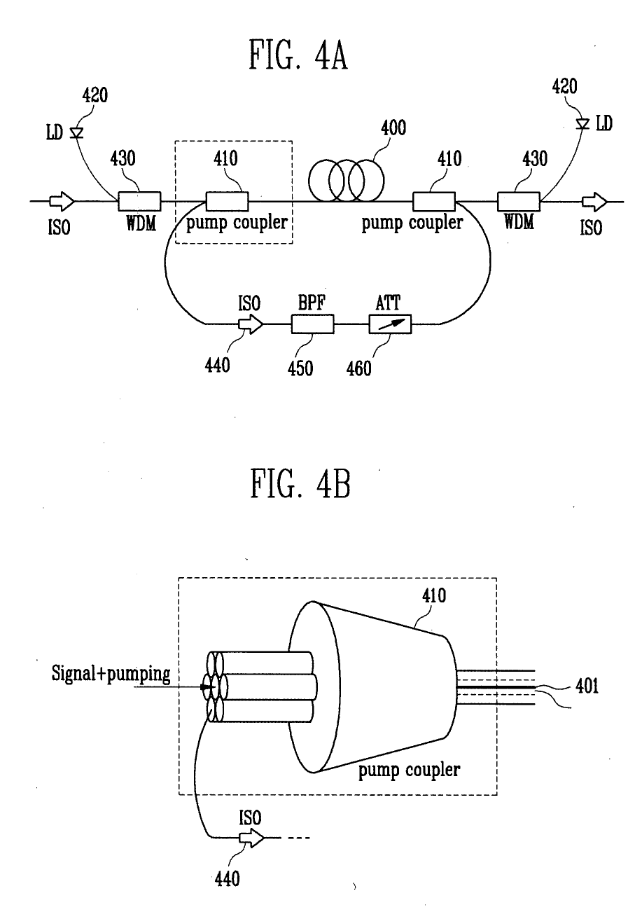

FIG. 4A is a diagram illustrating a gain-clamped optical amplifier using a double-clad fiber according to a third exemplary embodiment of the present invention, and FIG. 4B is a diagram illustrating a pump coupler shown in FIG. 4A in detail.

A gain-clamped optical fiber having a double-clad structure according to the third exemplary embodiment of the present invention has the same configuration as in the second exemplary embodiment in terms of cavity and gain-clamped optical fiber having the double-clad structure. Therefore, a detailed description of the cavity will be omitted.

Referring to FIG. 4A, an optical signal passing through an ISO and pump light output from a laser diode 420 are merged in a WDM coupler 430, and the merged light is incident on a core 401 of an optical fiber 400 having the double-clad structure through a pump coupler 410.

To detail this with reference to FIG. 4B, the light (optical signal and pump light) merged in the WDM coupler 430 are incident on a central optical fiber of seven optical fibers disposed at an input terminal of the pump coupler 410. Since the central optical fiber is connected to the core 401 of the optical fiber 400 having the double-clad structure, the merged light is incident on the core 401, and the pump light of the merged light excites a gain material doped into the core 401 to cause population inversion. At this time, spontaneous emission light is generated as in the second exemplary embodiment of the present invention, and a procedure of producing laser oscillation for gain clamping is the same as described above.

As in FIG. 3, two pump couplers 410, two WDM couplers 430, and two laser diodes 420 are shown at both ends of the optical fiber 400 having the double-clad structure in FIG. 4, but the number of these components may be varied depending on the configuration of the amplifier.

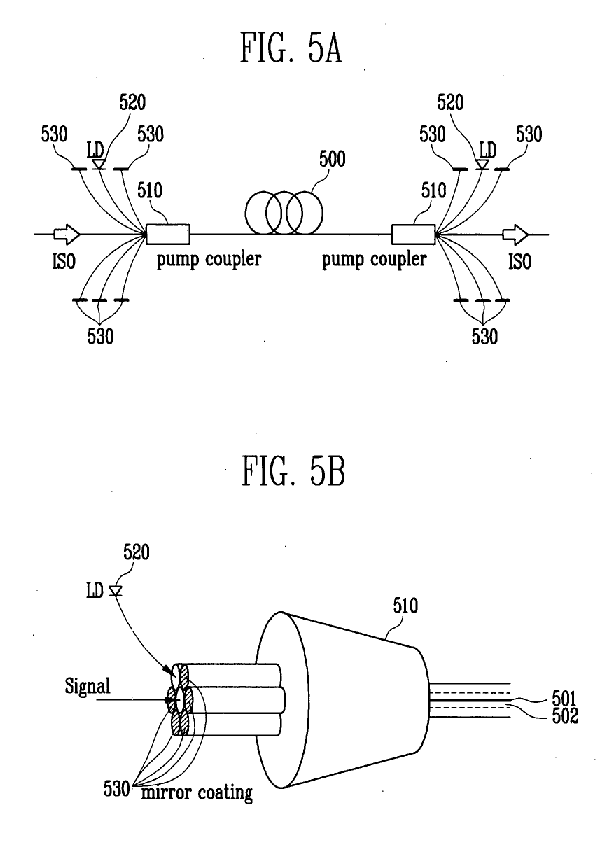

FIG. 5A is a diagram illustrating a gain-clamped optical amplifier using a double-clad fiber according to a fourth exemplary embodiment of the present invention, and FIG. 5B is a diagram illustrating a pump coupler and a reflector shown in FIG. 5A in detail.

A gain-clamped optical fiber having a double-clad structure according to the fourth exemplary embodiment of the present invention includes an optical fiber 500 having a double-clad structure, a pump coupler 510, a laser diode 520, and a reflector 530.

Referring to FIG. 5A, an optical signal and pump light generated in a laser diode 520 are incident on the optical fiber 500 having the double-clad structure through the pump coupler 510.

To detail this with reference to FIG. 5B, after the pump light output from the laser diode 520 is incident on some of the six optical fibers surrounding the central optical fiber disposed at an input terminal of the pump coupler 510, it is incident on a primary clad 502 of the optical fiber 500 having the double-clad structure through the pump coupler 510. The pump light entering the primary clad 502 excites a gain material doped into the core 501 to cause population inversion.

The optical signal passing through the ISO is then incident on the central optical fiber of the seven optical fibers formed at an input terminal of the pump coupler 510, and the optical signal is incident on the core 501 of the optical fiber 500 having the double-clad structure through the pump coupler 510. The incident optical signal is amplified while passing through the core 501. At this time, spontaneous emission light is generated in the core 510 as in the above-described exemplary embodiments, and some of the generated spontaneous emissions are totally guided along the primary clad 502, and some of it is amplified while crossing the core 501.

Such spontaneous emission light propagating along the primary clad is reflected by reflectors 530 at both ends of the optical fiber 500 having the double-clad structure to propagate back and forth. Here, the reflector 530 may be a general mirror or an optical fiber coated with a dielectric.

The spontaneous emission light is continuously reflected by the reflectors 530 disposed at both ends of the optical fiber 500 having the double-clad structure and thereby amplified, achieving laser oscillation.

The produced laser signal has a complementary relationship with an optical signal while adjusting a value of the population inversion. That is, the power of the laser formed in the primary clad 502 increases when the optical signal becomes weaker and decreases when the optical signal becomes stronger, so that the gain of the optical amplifier is clamped.

Two pump couplers 510, two laser diodes 520, and ten reflectors 530 are shown at both ends of the optical fiber 500 having the double-clad structure in FIG. 5, but the numbers of the components may be adjusted for effective gain clamping as in other exemplary embodiments of the present invention.

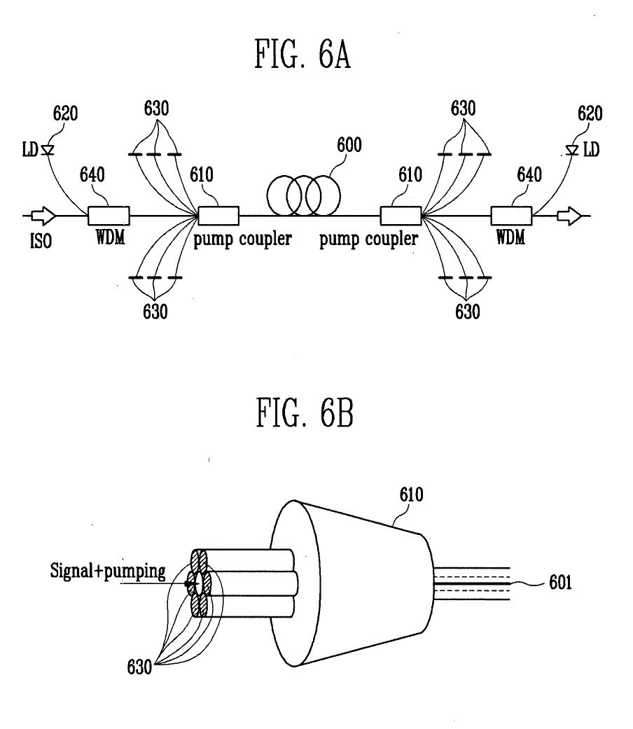

FIG. 6A is a diagram illustrating a gain-clamped optical amplifier using a double-clad fiber according to a fifth exemplary embodiment of the present invention, and FIG. 6B is a diagram illustrating a pump coupler and a reflector shown in FIG. 6A in detail.

The gain-clamped optical amplifier having the double-clad structure according to the fifth exemplary embodiment of the present invention includes an optical fiber 600 having a double-clad structure, a pump coupler 610, a laser diode 620, a reflector 630, and a WDM coupler 640.

The gain-clamped optical amplifier having the double-clad structure according to the fifth exemplary embodiment of the present invention differs from the gain-clamped optical amplifier having the double-clad structure according to the fourth exemplary embodiment in that the pump light is not directly incident on the pump coupler 610 but rather is merged with an optical signal through the WDM coupler 620 to be incident on the pump coupler. Accordingly, six optical fibers surrounding a central optical fiber disposed at an input terminal of the pump coupler 610 form a reflector 630. Portions of the following description which overlap with the above description of the fourth exemplary embodiment of the present invention will be omitted.

Referring to FIG. 6A, an optical signal passing through an ISO and pump light output from a laser diode 620 are merged in a WDM coupler 640, and the merged light is incident on a core 601 of an optical fiber 600 having the double-clad structure through a pump coupler 610.

To detail this with reference to FIG. 6B, the light (optical signal and pump light) merged in the WDM coupler 640 is incident on a central optical fiber of seven optical fibers disposed at an input terminal of the pump coupler 610. Since the central optical fiber is connected to the core 601 of the optical fiber 600 having the double-clad structure, the merged light is incident on the core 601, and the pump light of the merged light excites a gain material doped into the core 601 to cause population inversion. At this time, spontaneous emission light is generated as in the second exemplary embodiment of the present invention, and a procedure of producing laser oscillation for gain clamping is the same as described above.

Two pump couplers 610, two WDM couplers 640, two laser diodes 620, and twelve reflectors 630 are shown at both ends of the optical fiber 600 having the double-clad structure in FIG. 6, but the number of the components may be adjusted depending on the configuration of the invention.

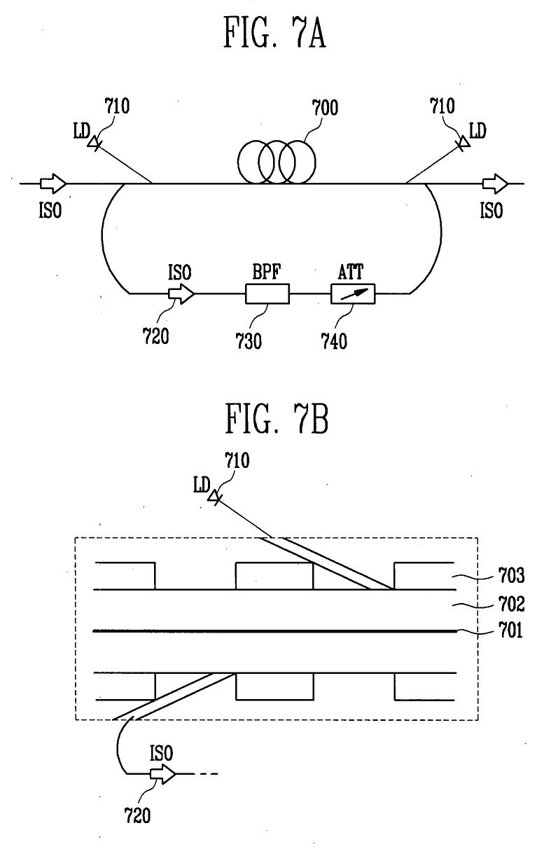

FIG. 7A is a diagram illustrating a gain-clamped optical amplifier using a double-clad fiber according to a sixth exemplary embodiment of the present invention, and FIG. 7B is a diagram illustrating coupling of an optical fiber shown in FIG. 7A in detail.

Referring to FIG. 7A, the gain-clamped optical amplifier having the double-clad structure according to the sixth exemplary embodiment of the present invention includes an optical fiber 700 having a double-clad structure, a laser diode 710, an ISO 720, a BPF 730, and an ATT 740.

Referring to FIG. 7B, the secondary clad 703 of the optical fiber 700 having the double-clad structure is partially removed, and pump light output from the laser diode 710 is directly incident on the primary clad 720 in the region where the secondary clad 703 is removed. Such a structure is disclosed in U.S. Pat. No. 5,999,673 entitled “Coupling Arrangement Between a Multi-Mode Light Source and an Optical Fiber Through an Intermediate Optical Fiber Length”, and CLEO 2001 technical digest, Page: 116, “A New Side Coupling Method for Double Clad Fiber Amplifiers”, F. Hakimi, H. Hakimi, MIT Lincoln Laboratory.

The directly incident pump light through the primary clad 702 excites a gain material doped into the core 701 to cause population inversion. At this time, the spontaneous emission light is generated as in the second exemplary embodiment of the present invention, and a procedure of producing laser oscillation for gain clamping is the same as described above.

In addition, a cavity including the ISO 720, BPF 730, and ATT 740 is directly connected to the primary clad 702 in the region where the secondary clad 703 is removed, and a role of the cavity is the same as in the second exemplary embodiment and thus a description thereof will be omitted.

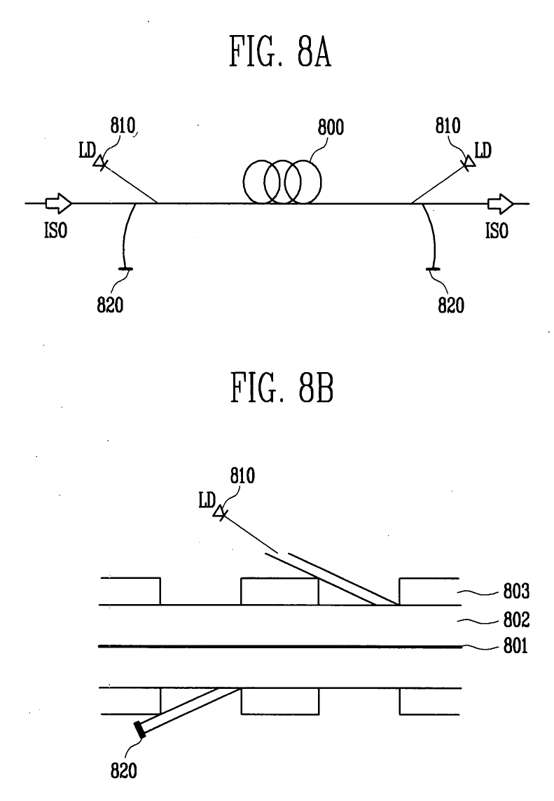

FIG. 8A is a diagram illustrating a gain-clamped optical amplifier using a double-clad fiber according to a seventh exemplary embodiment of the present invention, and FIG. 8B is a diagram illustrating coupling of an optical fiber and a reflector shown in FIG. 8A in detail.

Referring to FIG. 8A, the gain-clamped optical amplifier having the double-clad structure according to the seventh exemplary embodiment of the present invention includes an optical fiber 800 having a double-clad structure, a laser diode 810, and a reflector 820.

Referring to FIG. 8B, a secondary clad 803 of the optical fiber 800 having the double-clad structure is/partially removed as shown in FIG. 7B, and pump light output from the laser diode 810 is directly incident on the primary clad 802 in the region where the secondary clad 803 is removed.

The directly incident pump light through the primary clad 802 excites a gain material doped into the core 801 to cause population inversion. At this time, the spontaneous emission light is generated as in the second exemplary embodiment of the present invention, and a procedure of producing laser oscillation for gain clamping is the same as described above.

Since the reflector 820 is formed in the region where the secondary clad 803 is removed, spontaneous emission light is amplified while continuously crossing the core of the optical fiber 800 having the double-clad structure. Cavity using the reflector 820 is the same in the first exemplary embodiment of the present invention and thus a detailed description thereof will be omitted.

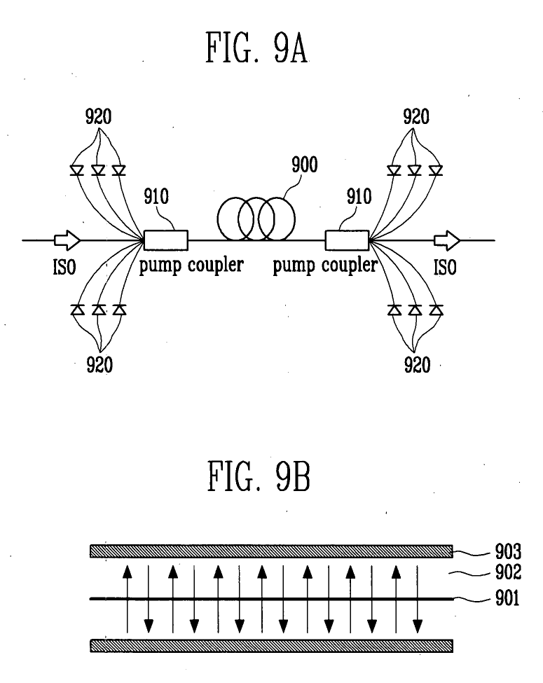

FIG. 9A is a diagram illustrating a gain-clamped optical amplifier using a double-clad fiber according to an eighth exemplary embodiment of the present invention, and FIG. 9B is a diagram illustrating a double-clad fiber shown in FIG. 9A in detail.

Referring to FIG. 9A, the gain-clamped optical amplifier having the double-clad structure according to the eighth exemplary embodiment of the present invention includes an optical fiber 900 having a double-clad structure, a pump coupler 910, and a laser diode 920. In addition, referring to FIG. 9B, a secondary clad 903 of the optical fiber 900 having the double-clad structure is composed of a reflector, which is different from other exemplary embodiments of the present invention.

When pump light output from the laser diode 920 is incident on the primary clad 902 of the optical fiber 900 having the double-clad structure through the pump coupler 910, a gain material doped into the core 901 is excited to cause population inversion, as in the other exemplary embodiments of the present invention. At this time, components which do not propagate along the core among spontaneous emission light emitted from the population-inverted gain material, in particular, components emitting vertically from the core, are reflected by the secondary clad 903 composed of the reflector to cause laser oscillation on a transverse section of the optical fiber 900 having the double-clad structure. The principle of clamping the gain using the laser oscillation is the same as in the above-described exemplary embodiments.

According to the present invention as described above, laser oscillation by amplification of spontaneous emission light is produced in a primary clad, so that optical amplification can be accomplished without bandwidth loss of an incident optical signal.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A gain-clamped optical amplifier using a double-clad fiber, comprising:
an optical fiber including a core doped with a gain material for amplifying an optical signal, a primary clad adjacent to the outside of the core and having a lower refractive index than the core, and a secondary clad adjacent to the outside of the primary clad and having a lower refractive index than the primary clad;
a light emitting element emitting a pump light for population inversion of the gain material; and
a cavity unit producing a gain clamping laser in the primary clad by resonating spontaneous emission light emitted from the gain material population-inverted by the pump light.

2. The gain-clamped optical amplifier using a double-clad fiber according to claim 1, further comprising:
an optical coupler merging an incident optical signal with pump light output from the light emitting element and outputting the incident optical signal and the pump light to the optical fiber.

3. The gain-clamped optical amplifier using a double-clad fiber according to claim 1, wherein the cavity unit includes reflectors which reflect light and are disposed at both ends of the primary clad.

4. The gain-clamped optical amplifier using a double-clad fiber according to claim 2, further comprising:
an objective lens making the optical signal and the pump light output from the optical coupler incident on the core of the optical fiber.

5. The gain-clamped optical amplifier using a double-clad fiber according to claim 2, wherein the optical coupler is a wavelength division multiplexing (WDM) coupler which merges and outputs the optical signal and the pump light.

6. The gain-clamped optical amplifier using a double-clad fiber according to claim 2, wherein the cavity unit includes an optical path connecting the optical couplers disposed at both ends of the optical fiber.

7. The gain-clamped optical amplifier using a double-clad fiber according to claim 6, wherein the optical coupler is a pump coupler which makes the optical signal incident on the core of the optical fiber and makes the pump light incident on the primary clad of the optical fiber.

8. The gain-clamped optical amplifier using a double-clad fiber according to claim 6, wherein the optical coupler comprises:
a wavelength division multiplexing (WDM) coupler which merges and outputs the optical signal and the pump light; and
a pump coupler which makes the optical signal and the pump light output from the WDM coupler incident on the core of the optical fiber.

9. The gain-clamped optical amplifier using a double-clad fiber according to claim 2, wherein the cavity unit includes a reflector which reflects light and is disposed on at least one input terminal of each of the optical couplers disposed at both ends of the optical fiber.

10. The gain-clamped optical amplifier using a double-clad fiber according to claim 9, wherein the optical coupler is a pump coupler which makes the optical signal incident on the core of the optical fiber and makes the pump light incident on the primary clad of the optical fiber.

11. The gain-clamped optical amplifier using a double-clad fiber according to claim 9, wherein the optical coupler comprises:
a wavelength division multiplexing (WDM) coupler which merges and outputs the optical signal and the pump light; and
a pump coupler which makes the optical signal and the pump light output from the WDM coupler incident on the core of the optical fiber.

12. The gain-clamped optical amplifier using a double-clad fiber according to claim 1, wherein the optical fiber comprises regions where the second clad is removed at both ends of the optical fiber, the pump light output from the light emitting element is directly incident on the primary clad through the regions where the secondary clad is removed, and the cavity unit is directly connected to the primary clad of the optical fiber through the regions where the secondary clad is removed.

13. The gain-clamped optical amplifier using a double-clad fiber according to claim 12, wherein the cavity unit includes an optical path which connects the regions where the secondary clad is partially removed at both ends of the optical fiber.

14. The gain-clamped optical amplifier using a double-clad fiber according to claim 12, wherein the cavity unit includes a reflector which reflects incident light.

15. The gain-clamped optical amplifier using a double-clad fiber according to claim 6, wherein the cavity unit includes at least one of an isolator, a band pass filter, and an attenuator.

16. The gain-clamped optical amplifier using a double-clad fiber according to claim 13, wherein the cavity unit includes at least one of an isolator, a band pass filter, and an attenuator.

17. A gain-clamped optical amplifier using a double-clad fiber, comprising:
an optical fiber including a core doped with a gain material for amplifying an optical signal, a primary clad adjacent to the outside of the core and having a lower refractive index than the core, and a secondary clad adjacent to the outside of the primary clad and having a reflector reflecting incident light;
a pump coupler disposed at both ends of the optical fiber, merging a plurality of input terminals into one output terminal, and outputting a signal to the optical fiber; and
a light emitting element connected to the pump coupler and emitting a pump light for population inversion of the gain material,
wherein the secondary clad reflects spontaneous emission light emitted from the gain material population-inverted by the pump light to be amplified in the primary clad so that laser oscillation is achieved.

18. The gain-clamped optical amplifier using a double-clad fiber according to claim 3, wherein the reflector is a mirror or an optical fiber with its terminated surface coated with a dielectric.

19. The gain-clamped optical amplifier using a double-clad fiber according to claim 17, wherein the reflector is a mirror or an optical fiber with its terminated surface coated with a dielectric.

20. The gain-clamped optical amplifier using a double-clad fiber according to claim 1, wherein the core is an optical fiber doped with a rare earth element.

21. The gain-clamped optical amplifier using a double-clad fiber according to claim 17, wherein the core is an optical fiber doped with a rare earth element.

22. The gain-clamped optical amplifier using a double-clad fiber according to claim 1, wherein the primary clad is an optical fiber formed of silica.

23. The gain-clamped optical amplifier using a double-clad fiber according to claim 17, wherein the primary clad is an optical fiber formed of silica.

24. The gain-clamped optical amplifier using a double-clad fiber according to claim 1, wherein the secondary clad is a polymer having a lower refractive index than the primary clad, or an optical fiber formed of silica doped with fluorine and having a lower refractive index than the primary clad.
